(19) United States
(12) Patent Application Publication
(10) Pub. No.: US 2015/0086055 A1
(43) Pub. Date: Mar. 26, 2015

(54) PORTABLE ELECTRONIC DEVICE

(71) Applicant: KYOCERA Corporation, Kyoto-shi (JP)

(72) Inventor: Seiji KATO, Hashima-shi (JP)

(73) Assignee: KYOCERA Corporation

(21) Appl. No.: 14/557,363

(22) Filed: Dec. 1, 2014

Related U.S. Application Data
(63) Continuation of application No. PCT/JP2013/064691, filed on May 28, 2013.

(30) Foreign Application Priority Data
May 29, 2012 (JP) 2012-121997

(51) Int. Cl. H04R 1/02

(52) U.S. Cl. CPC H04R 1/02; H04R 2499/11
USPC 381/334

(57) ABSTRACT

A portable electronic device includes a receiver, a sound output module, and a controller configured to control the receiver and the sound output module. Upon occurrence of at least one of an ear of a user of the portable electronic device approaching the portable electronic device and the ear of the user coming into contact with the portable electronic device while performing a sound output process of causing the sound output module to output sound, the controller performs a sound playback process of playing back the sound output from the sound output module in the sound output process and causing the receiver to output the sound.

The present application is a bypass continuation of international patent application PCT Application No. PCT/JP2013/064691, filed on May 28, 2013, entitled “PORTABLE ELECTRONIC DEVICE”, which claims the benefit of Japanese Application No. 2012-121997, filed on May 29, 2012, entitled “PORTABLE ELECTRONIC DEVICE”. The disclosure of each of the above is incorporated herein by reference in its entirety.

### TECHNICAL FIELD

Embodiments of the present disclosure relates to a portable electronic device.

### BACKGROUND ART

Various technologies have been conventionally proposed for portable electronic devices.

### SUMMARY

A portable electronic device according to an aspect includes a receiver, a sound output module located separately from the receiver, and a controller configured to control the receiver and the sound output module. Upon occurrence of at least one of an ear of a user of the portable electronic device approaching the portable electronic device and the ear of the user coming into contact with the portable electronic device while performing a sound output process of causing the sound output module to output sound, the controller performs a sound playback process of playing back the sound output from the sound output module in the sound output process and causing the receiver to output the played-back sound.

### BRIEF DESCRIPTION OF THE DRAWINGS

FIG. 1 is a perspective view showing an external appearance of a portable electronic device.

FIG. 2 is a front view showing the external appearance of the portable electronic device.

FIG. 3 is a rear view showing the external appearance of the portable electronic device.

FIG. 4 is a side view showing the external appearance of the portable electronic device.

FIG. 5 is a block diagram mainly showing an electrical configuration of the portable electronic device.

FIG. 6 is a view showing programs stored in a storage module.

FIG. 7 is a top view showing a structure of a piezoelectric vibration element.

FIG. 8 is a side view showing the structure of the piezoelectric vibration element.

FIG. 9 is a view showing a state in which the piezoelectric vibration element produces flexural vibrations.

FIG. 10 is another view showing the state in which the piezoelectric vibration element produces flexural vibrations.

FIG. 11 is a view showing a vertical cross-sectional structure of the portable electronic device.

FIG. 12 is a plan view showing a cover panel viewed from an inner main surface side.

FIG. 13 is a view for describing air conducted sound and conduction sound.

FIG. 14 is a flowchart showing an operation of the portable electronic device.

FIG. 15 is a view showing a state in which a user's ear is close to the portable electronic device.

FIG. 16 is a flowchart showing an operation of the portable electronic device.

### DESCRIPTION OF EMBODIMENT

<External Appearance of Electronic Device>

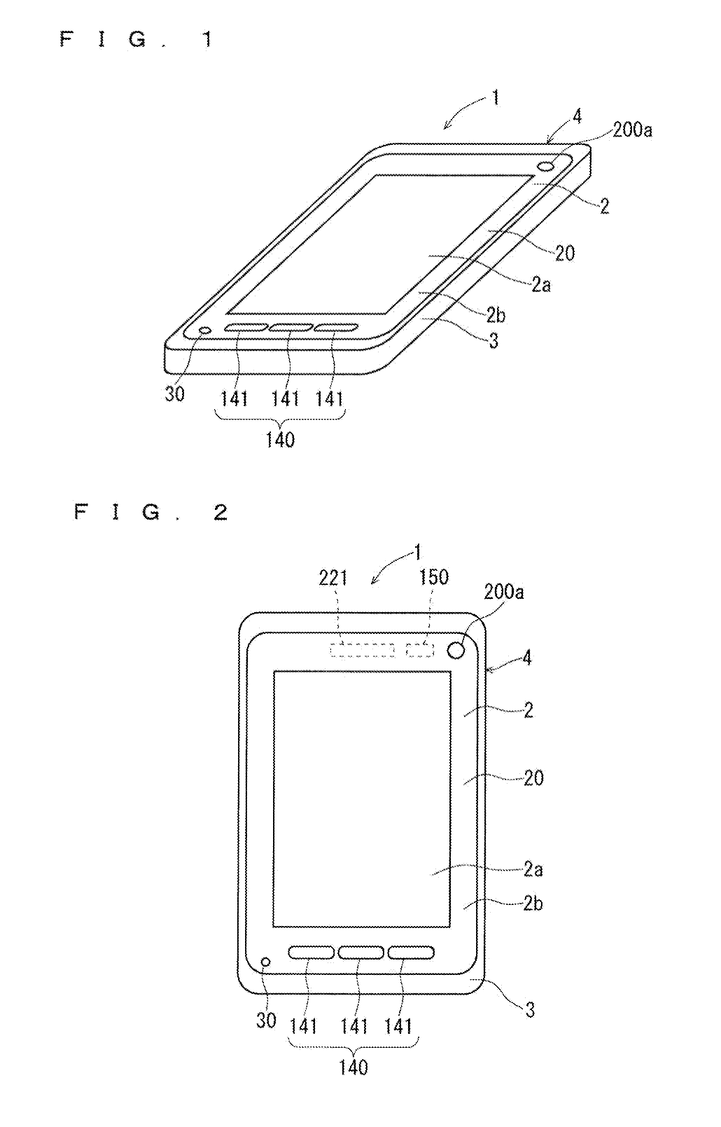

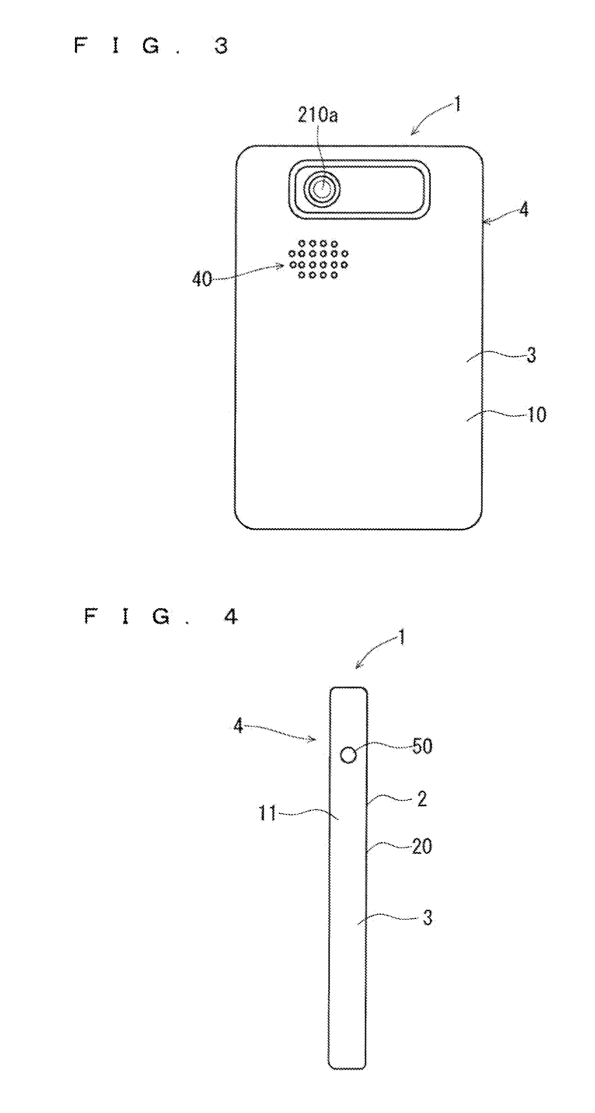

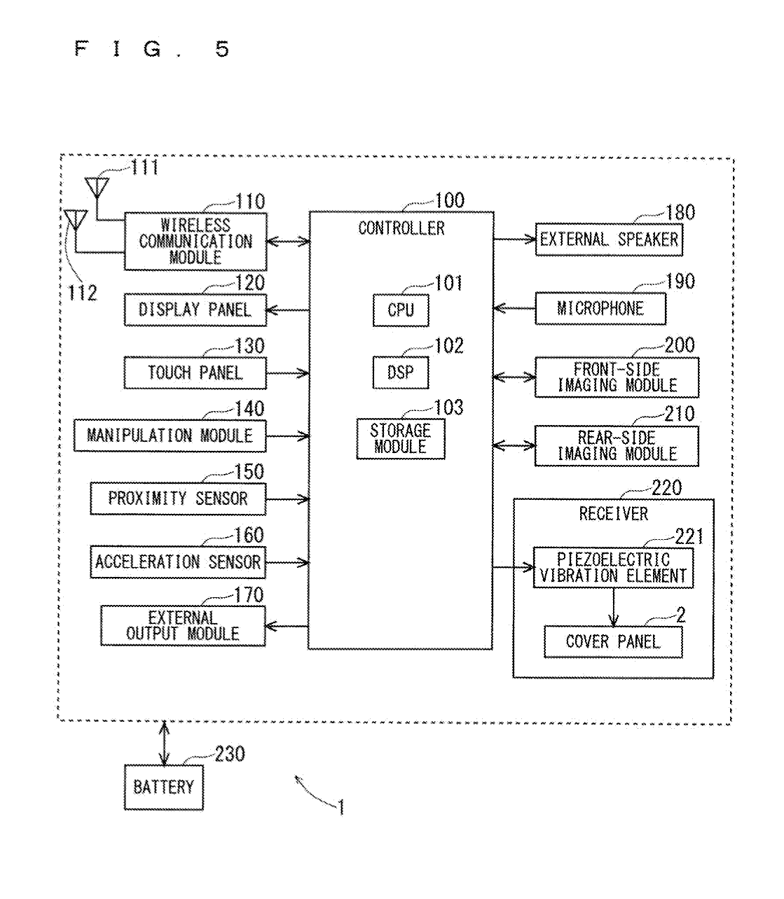

FIGS. 1 to 4 are a perspective view, a front view, a rear view, and a side view showing an external appearance of a portable electronic device 1 according to an embodiment, respectively. FIG. 4 shows the portable electronic device 1 when viewed from the left side of the sheet of FIG. 2. The portable electronic device 1 according to this embodiment is, for example, a mobile phone.

As shown in FIGS. 1 to 4, the portable electronic device 1 includes a cover panel 2 and a case part 3. The cover panel 2 and the case part 3 are combined to constitute a device case 4 having a plate shape substantially rectangular in plan view.

The cover panel 2 has a substantially rectangular shape in plan view. The cover panel 2 forms a part in a front part of the portable electronic device 1 other than a peripheral part thereof. The cover panel 2 is formed of, for example, a transparent glass or a transparent acrylic resin. The case part 3 forms the peripheral part of the front part, a lateral part, and a rear part of the portable electronic device 1. The case part 3 is formed of, for example, a polycarbonate resin.

The cover panel 2 is provided with a display part 2a on which various types of information such as characters, symbols, and diagrams are displayed. The display part 2a has, for example, a rectangular shape in plan view. A peripheral part 2b that surrounds the display part 2a in the cover panel 2 is black through, for example, application of a film. The peripheral part 2b accordingly serves as a non-display part on which no information is displayed. Attached to an inner main surface of the cover panel 2 is a touch panel 130, which will be described below. This allows the user to provide various instructions to the portable electronic device 1 by manipulating the display part 2a of the cover panel 2 with his/her finger.

Provided inside the device case 4 is a manipulation module 140 including a plurality of manipulation buttons 141. Each manipulation button 141 is a so-called “hard key,” and the surface thereof is exposed from a lower-side end portion of an outer main surface 20 of the cover panel 2. Made in the lower-side end portion of the cover panel 2 are holes for exposing the plurality of manipulation buttons 141. Additionally, a microphone hole 30 is made in the lower-side end portion of the cover panel 2. Exposed from an upper-side end portion of the outer main surface 20 of the cover panel 2 is an imaging lens 200a of a front-side imaging module 200, which will be described below. Although three manipulation buttons 141 being “hard keys” are provided in the portable electronic device 1 according to this embodiment, the number of the manipulation buttons 141 may be appropriately changed. Alternatively, no manipulation buttons 141 may be provided.

As shown in FIG. 2, provided inside the device case 4 are a piezoelectric vibration element 221 and a proximity sensor 150 described below. As shown in FIG. 3, speaker holes 40 are made in a rear surface 10 of the portable electronic device 1, namely, in a rear surface of the device case 4. Exposed from the rear surface 10 of the portable electronic device 1 is an imaging lens 210a of a rear-side imaging module 210, which will be described below. As shown in FIG. 4, an external terminal 50 is provided on a left lateral surface 11 of the portable electronic device 1 when the portable electronic device 1 is viewed from the cover panel 2 side. The external terminal 50 is wired with earphones or headphones. Hereinafter, the earphones and headphones may be collectively called a “sound output device.”

<Electrical Configuration of Portable Electronic Device>

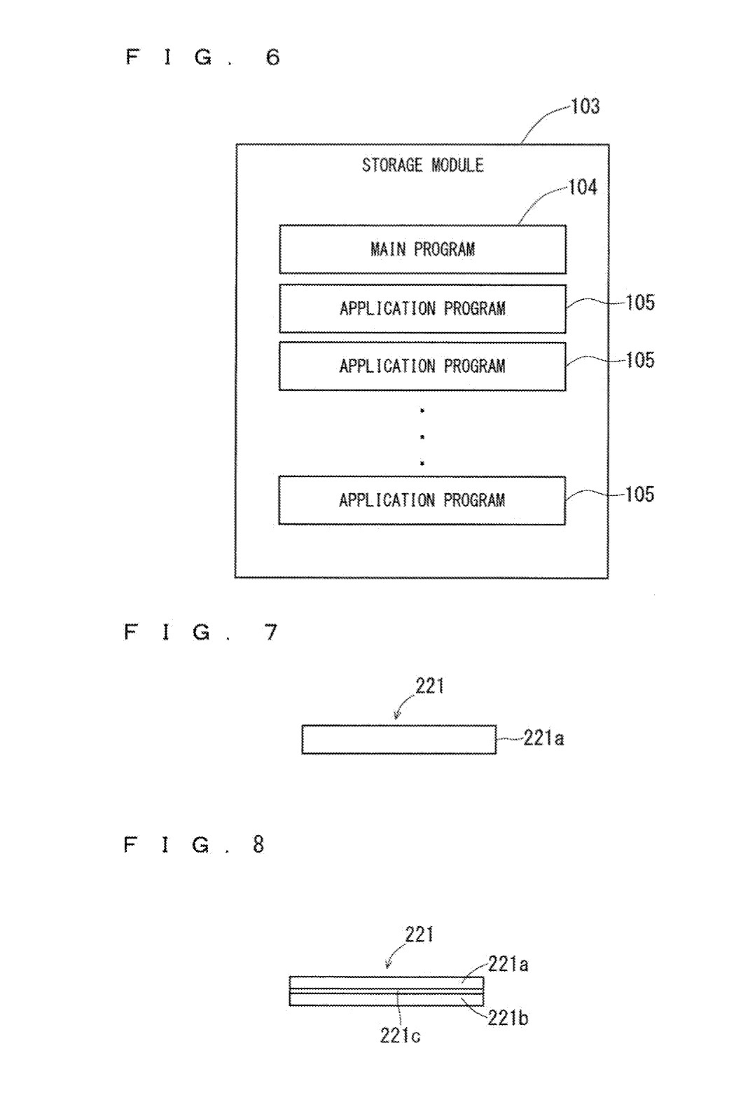

FIG. 5 is a block diagram mainly showing an electrical configuration of the portable electronic device 1. As shown in FIG. 5, the portable electronic device 1 includes a controller 100, a wireless communication module 110, a display panel 120, the touch panel 130, the manipulation module 140, the proximity sensor 150, an acceleration sensor 160, and an external output module 170. The portable electronic device 1 further includes a receiver 220 configured with the piezoelectric vibration element 221 and the cover panel 2, an external speaker 180, a microphone 190 being a sound input module, the front-side imaging module 200, the rear-side imaging module 210, and a battery 230. These components of the portable electronic device 1 except for the cover panel 2 are housed in the device case 4.

The controller 100 controls other components of the portable electronic device 1 to collectively manage the operation of the portable electronic device 1. The controller 100 mainly includes a CPU (central processing unit) 101, a DSP (digital signal processor) 102, and a storage module 103.

The storage module 103 is configured with a non-transitory recording medium that can be read by the controller 100 (CPU 101 and DSP 102), such as a ROM (read only memory) and a RAM (random access memory). As shown in FIG. 6, the storage module 103 stores a main program 104 being a control program for controlling the operation of the portable electronic device 1, specifically, the components such as the wireless communication module 110 and the display panel 120 included in the portable electronic device 1, a plurality of application programs 105, and the like. The various functions of the controller 100 can be implemented by the CPU 101 and the DSP 102 executing the various programs in the storage module 103.

The storage module 103 may include a computer-readable, non-transitory recording medium, except for the ROM and RAM. The storage module 103 may include, for example, a small hard disk drive, a small SSD (solid state drive), and the like.

The wireless communication module 110 has an antenna 111. The wireless communication module 110 receives, through the antenna 111, a signal from a mobile phone different from the portable electronic device 1 or a communication device such as a web server connected to the Internet via a base station. The wireless communication module 110 performs amplification processing and down-conversion processing on the received signal and then outputs a resultant signal to the controller 100. The controller 100 performs modulation processing or other processing on a received signal that has been input, to thereby obtain a sound signal indicative of voice or music contained in the received signal. Also, the wireless communication module 110 performs up-conversion processing and amplification processing on a transmission signal including the sound signal or the like that has been generated by the controller 100, to thereby wirelessly transmit the processed transmission signal from the antenna 111. The transmission signal from the antenna 111 is received, via the base station, by a mobile phone different from the portable electronic device 1 or a communication device connected to the Internet.

The wireless communication module 110 also has a television antenna 112 for receiving a television broadcast, and outputs a reception signal received through the television antenna 112 to the controller 100. The controller 100 obtains a moving image, voice, and the like included in the input reception signal of the television broadcast.

The display panel 120 is, for example, a liquid crystal display panel or an organic EL panel. The display panel 120 displays various types of information such as characters, symbols, and graphics under control of the controller 100. The information, which is to be displayed on the display panel 120, is displayed in the display part 2a of the cover panel 2 to be visible to the user of the portable electronic device 1.

The touch panel 130 is, for example, a projected capacitive type touch panel. The touch panel 130 detects the contact of an object with the display part 2a of the cover panel 2. The touch panel 130 is bonded to the inner main surface of the cover panel 2 and includes two sheet-like electrode sensors disposed to face each other. The two electrode sensors are bonded together with a transparent adhesive sheet.

Formed in one of the electrode sensors are a plurality of elongated X electrodes that extend in the X-axis direction (for example, the horizontal direction of the portable electronic device 1) and are disposed parallel to each other. Formed in the other electrode sensor are a plurality of elongated Y electrodes that extend in the Y-axis direction (for example, the vertical direction of the portable electronic device 1) and are disposed parallel to each other. When the user's finger touches the display part 2a of the cover panel 2, a capacitance between the X electrode and the Y electrode located below the touched portion changes, so that the touch panel 130 detects the manipulation on (contact with) the display part 2a of the cover panel 2. A change in the capacitance between the X electrode and the Y electrode, which occurs in the touch panel 130, is transmitted to the controller 100. The controller 100 identifies, based on the capacitance change, the details of the manipulation made on the display part 2a of the cover panel 2, and performs the corresponding manipulation.

For each of the plurality of manipulation buttons 141, when the user presses a manipulation button 141, the manipulation module 140 outputs to the controller 100 a manipulation signal indicating that the manipulation button 141 has been pressed. The controller 100 identifies, based on the input manipulation signal, which manipulation button 141 of the plurality of manipulation buttons 141 has been manipulated and then performs the operation corresponding to the manipulation button 141 that has been manipulated.

The proximity sensor 150 is, for example, an infrared proximity sensor. The proximity sensor 150 outputs a detection signal when the object approaches the proximity sensor 150 within a predetermined distance. The detection signal is input to the controller 100. When the portable electronic device 1 is viewed from the cover panel 2 side (front side), as shown in FIG. 2, the proximity sensor 150 is located on the rear side of the upper-side end portion of the cover panel 2. Thus, when the human head or the like approaches the cover panel 2, the proximity sensor 150 outputs a detection signal. In other words, when the object approaches the front surface of the portable electronic device 1, the proximity sensor 150 outputs a detection signal.

The acceleration sensor 160 is, for example, a three-axis acceleration sensor. The acceleration sensor 160 detects, for each of the three detection axes perpendicular to one another, the acceleration along each detection axis and then outputs the detected acceleration to the controller 100.

The external output module 170 outputs sound to a sound output device to be connected to the external terminal 50. To be specific, the external output module 170 converts an electrical sound signal output from the controller 100 into a sound signal suitable for the sound output device, and then outputs the converted electrical sound signal to the external terminal 50. As a result, sound is output from the earphones or headphones connected to the external terminal 50.

The external speaker 180 is, for example, a dynamic speaker, which converts an electrical sound signal from the controller 100 into sound and then outputs the sound. The sound output from the external speaker 180 is output to the outside through the speaker holes 40 provided in the rear surface 10 of the portable electronic device 1. The sound output through the speaker holes 40 can be heard at the place remote from the portable electronic device 1.

The microphone 190 converts the sound input from the outside of the portable electronic device 1 into an electrical sound signal and then outputs the electrical sound signal to the controller 100. The sound from the outside of the portable electronic device 1 is taken inside the portable electronic device 1 through the microphone hole 30 provided in the front surface of the cover panel 2 to be input to the microphone 190. The microphone hole 30 may be provided in the lateral surface of the portable electronic device 1 or may be provided in the rear surface 10.

The front-side imaging module 200 is configured with the imaging lens 200a, an imaging element, and the like. The front-side imaging module 200 takes a still image and a moving image under the control of the controller 100. As shown in FIGS. 1 and 2, the imaging lens 200a is provided in the front surface of the portable electronic device 1. The front-side imaging module 200 can thus take an image of the object located on the front side (cover panel 2 side) of the portable electronic device 1.

The rear-side imaging module 210 is configured with the imaging lens 210a, an imaging element, and the like. The rear-side imaging module 210 takes a still image and a moving image under the control of the controller 100. As shown in FIG. 3, the imaging lens 210a is provided in the rear surface 10 of the portable electronic device 1. The rear-side imaging module 210 thus can take an image of the object located on the rear surface 10 side of the portable electronic device 1.

The receiver 220 transmits received sound to the user. The receiver 220 is configured with the piezoelectric vibration element 221 and the cover panel 2. The receiver 220 outputs sound with a volume smaller than that of the external speaker 180. The receiver 220 outputs the sound large enough for the user to hear when the user brings his/her ear near or into contact with the cover panel 2.

The piezoelectric vibration element 221 is provided on the inner main surface of the cover panel 2. The piezoelectric vibration element 221 is vibrated by the drive voltage applied from the controller 100. The controller 100 generates a drive voltage based on a sound signal, and then applies the drive voltage to the piezoelectric vibration element 221. The piezoelectric vibration element 221 is vibrated based on a sound signal by the controller 100, whereby the cover panel 2 vibrates based on the sound signal, transmitting the received sound to the user. The receiver 220 will be described below in detail.

The battery 230 outputs the power supply for the portable electronic device 1. The power supply output from the battery 230 is supplied to the electronic components included in the controller 100, the wireless communication module 110, and the like of the portable electronic device 1.

The storage module 103 stores various application programs 105 (hereinafter, merely referred to as “applications 105”). The storage module 103 stores a voice conversation application for voice conversation, a videophone application for videophone communication being one type of conversation, a browser for displaying a website, a mail application for creating, browsing, transmitting, and receiving an email, an application for displaying the still image data stored in the storage module 103, and a music playback application for playing back the music data stored in the storage module 103.

Also, the storage module 103 stores a moving image playback application (hereinafter, referred to as “stored moving image playback application”) for playing back the sound data and moving image data (moving image data with sound) that are associated with each other and are stored in the storage module 103, a moving image playback application (hereinafter, referred to as “delivered moving image playback application”) for playing back the moving image data with sound delivered from a website by, for example, streaming or progressive downloading, a market application for downloading an application from a web server that provides applications for a fee or for free, a game application for playing a game such as a puzzle game in the portable electronic device 1, and a television viewing application for recording and playing back a television broadcast. Examples of the moving image data with sound in the storage module 103 include the moving image data with sound obtained by recording the news program, English conversation program, and other program to be televised and the moving image data with sound obtained by taking a moving image with a camcorder.

The controller 100 executing the main program 104 reads and executes the application 105 in the storage module 103, so that the controller 100 controls the other components in the portable electronic device 1, such as the wireless communication module 110, the display panel 120, and the receiver 220. As a result, the portable electronic device 1 performs the function corresponding to this application 105.

For example, in the case where the receiver 220 is set as the voice output source, the controller 100 executing the voice conversation application controls the wireless communication module 110, the microphone 190, and the receiver 220. As a result, the portable electronic device 1 uses the receiver 220 for conversation with the communication partner device. Alternatively, in the case where the external speaker 180 is set as the voice output source, the controller 100 executing the voice conversation application controls the wireless communication module 110, the external speaker 180, and the microphone 190. As a result, the portable electronic device 1 uses the external speaker 180 for conversation with the communication partner device. Still alternatively, in the case where the external output module 170 is set as the voice output source, the controller 100 executing the voice conversation application controls the wireless communication module 110, the external output module 170, and the microphone 190. As a result, the portable electronic device 1 uses the external output module 170 for conversation with the communication partner device.

In the case where the external speaker 180 is set as the voice output source, the controller 100 executing a videophone application controls the wireless communication module 110, the display panel 120, the external speaker 180, the microphone 190, and the front-side imaging module 200. As a result, the portable electronic device 1 uses the external speaker 180 for videophone communication with the communication partner device.

In the case where the external output module 170 is set as the voice output source is set, the controller 100 executing the videophone application controls the wireless communication module 110, the display panel 120, the external output module 170, the microphone 190, and the front-side imaging module 200. As a result, the portable electronic device 1 uses the external output module 170 for videophone communication with the communication partner device.

In the case where the external speaker 180 is set as the sound output source, the controller 100 executing the stored moving image playback application controls the display panel 120 and the external speaker 180. As a result, the portable electronic device 1 plays back the moving image data with sound in the storage module 103.

In the case where the external speaker 180 is set as the sound output source, the controller 100 executing the delivered moving image playback application controls the wireless communication module 110, the display panel 120, and the external speaker 180. As a result, the portable electronic device 1 plays back the moving image data with sound delivered from the communication partner device by, for example, streaming.

<Details of Piezoelectric Vibration Element>

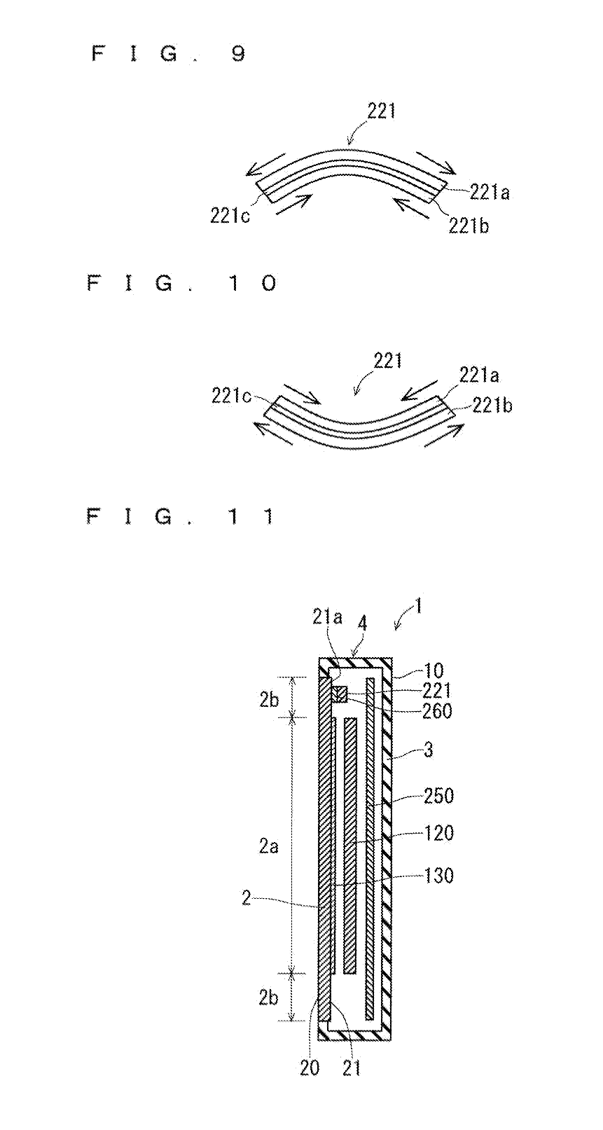

FIGS. 7 and 8 are a top view and a side view showing the structure of the piezoelectric vibration element 221, respectively. As shown in FIGS. 7 and 8, the piezoelectric vibration element 221 is long in one direction. To be specific, the piezoelectric vibration element 221 has an elongated plate shape rectangular in plan view. The piezoelectric vibration element 221 has, for example, a bimorph structure. The piezoelectric vibration element 221 includes a first piezoelectric ceramic plate 221a and a second piezoelectric ceramic plate 221b bonded to each other with a shim material 221c therebetween.

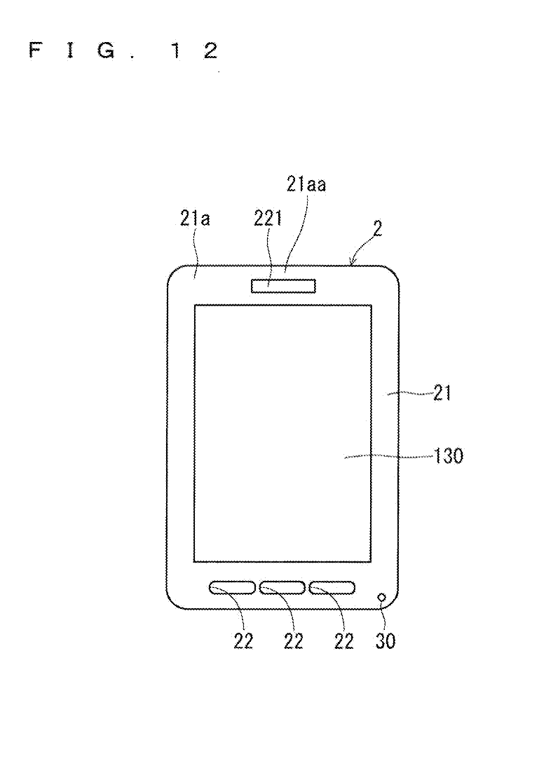

In the piezoelectric vibration element 221, a positive voltage is applied to the first piezoelectric ceramic plate 221a and a negative voltage is applied to the second piezoelectric ceramic plate 221b, so that the first piezoelectric ceramic plate 221a expands in the long-side direction and the second piezoelectric ceramic plate 55b contracts in the long-side direction. This causes, as shown in FIG. 9, the piezoelectric vibration element 221 to flex toward the first piezoelectric ceramic plate 221a in a convex manner.

In the piezoelectric vibration element 221, meanwhile, a negative voltage is applied to the first piezoelectric ceramic plate 221a and a positive voltage is applied to the second piezoelectric ceramic plate 221b, so that the first piezoelectric ceramic plate 221a contracts in the long-side direction and the second piezoelectric ceramic plate 221b expands in the long-side direction. This causes, as shown in FIG. 10, the piezoelectric vibration element 221 to flex toward the second piezoelectric ceramic plate 221b in a convex manner.

The piezoelectric vibration element 221 alternately enters the state of FIG. 9 and the state of FIG. 10, to thereby produce flexural vibrations. The controller 100 causes an AC voltage, which alternates between positive and negative voltages, to be applied between the first piezoelectric ceramic plate 221a and the second piezoelectric ceramic plate 221b, causing the piezoelectric vibration element 221 to produce flexural vibrations.

While the piezoelectric vibration element 221 shown in FIGS. 7 to 10 is provided with a single structure configured with the first piezoelectric ceramic plate 221a and the second piezoelectric ceramic plate 221b that are bonded with the shim material 221c sandwiched therebetween, a plurality of the above-mentioned structures may be laminated.

<Position at which Piezoelectric Vibration Element is Disposed>

FIG. 11 is a view showing the cross-sectional structure in the vertical direction (long-side direction) of the portable electronic device 1. FIG. 12 is a plan view of the cover panel 2 when viewed from its inner main surface 21 side.

As shown in FIGS. 11 and 12, the touch panel 130 is bonded to the inner main surface 21 of the cover panel 2 so as to face the display part 2a of the cover panel 2. The display panel 120 being a display module is disposed to face the cover panel 2 and the touch panel 130. The touch panel 130 is thus located between the cover panel 2 and the display panel 120. The part of the cover panel 2, which faces the display panel 120, serves as the display part 2a.

Provided inside the device case 4 is a printed circuit board 250 on which various components such as the CPU 101 and the DSP 102 are mounted. The printed circuit board 250 is disposed to face the display panel 120 on the side closer to the rear surface 10 of the portable electronic device 1 than the display panel 120. As shown in FIG. 12, a plurality of holes 22 for respectively exposing the plurality of manipulation buttons 141 are made in the lower-side end portion of the cover panel 2.

The piezoelectric vibration element 221 is bonded to the inner main surface 21 of the cover panel 2 with an adhesive 260 such as a double-sided tape. The piezoelectric vibration element 221 is disposed, on the inner main surface 21 of the cover panel 2, at a position at which the piezoelectric vibration element 221 does not overlap the display panel 120 and the touch panel 130 in plan view of the cover panel 2 viewed from the inner main surface 21 side. In other words, when the cover panel 2 is viewed from the inner main surface 21 side in the thickness direction of the cover panel 2, the piezoelectric vibration element 221 is disposed, on the inner main surface 21, at a position at which the piezoelectric vibration element 221 does not overlap the display panel 120 and the touch panel 130. Therefore, the touch panel 130 and the display panel 120 are not located between the cover panel 2 and the piezoelectric vibration element 221.

The piezoelectric vibration element 221 is provided on an upper-side end portion 21a of the inner main surface 21 of the cover panel 2. To be specific, as shown in FIG. 12, the piezoelectric vibration element 221 is provided on a center portion 21aa in the horizontal direction (short-side direction perpendicular to the long-side direction) at the upper-side end portion 21a of the inner main surface 21 of the cover panel 2.

The piezoelectric vibration element 221 is disposed such that its long-side direction coincides with the horizontal direction of the cover panel 2. The piezoelectric vibration element 221 is disposed at the center portion 21aa of the upper-side end portion 21a of the inner main surface 21 of the cover panel 2 such that the center in the long-side direction thereof coincides with the center in the horizontal direction at the upper-side end portion 21a.

As shown in FIGS. 9 and 10 described above, the piezoelectric vibration element 221 that produces flexural vibrations has the largest displacement amount at the center in the long-side direction thereof. Thus, the piezoelectric vibration element 221 is disposed at the upper-side end portion 21a of the inner main surface 21 of the cover panel 2 such that the center in the long-side direction thereof coincides with the center in the horizontal direction at the upper-side end portion 21a, whereby the portion of the piezoelectric vibration element 221, at which a displacement amount of flexural vibrations is maximized, coincides with the center in the horizontal direction at the upper-side end portion 21a of the inner main surface 21 of the cover panel 2.

In the case where the touch panel 130 is located over the entire inner main surface 21 of the cover panel 2, the piezoelectric vibration element 221 may be disposed on the inner main surface 21 of the cover panel 2 with the touch panel 130 therebetween.

<Occurrence of Received Sound through Receiver>

In the receiver 220 according to this embodiment, the piezoelectric vibration element 221 causes the cover panel 2 to vibrate, so that air conducted sound and conduction sound are transmitted to the user from the cover panel 2. In other words, the vibrations of the piezoelectric vibration element 221 itself are transmitted to the cover panel 2, allowing for the transmission of air conducted sound and conduction sound to the user from the cover panel 2.

Herein, the air conducted sound is the sound recognized by the human brain when a sound wave (air vibrations), which has entered the external auditory meatus (so-called “earhole”), causes the eardrum to vibrate. Meanwhile, the conduction sound is the sound recognized by the human brain when the auricle is vibrated and vibrations of the auricle are transmitted to the eardrum, which causes the eardrum to vibrate. The air conducted sound and conduction sound will now be described in detail.

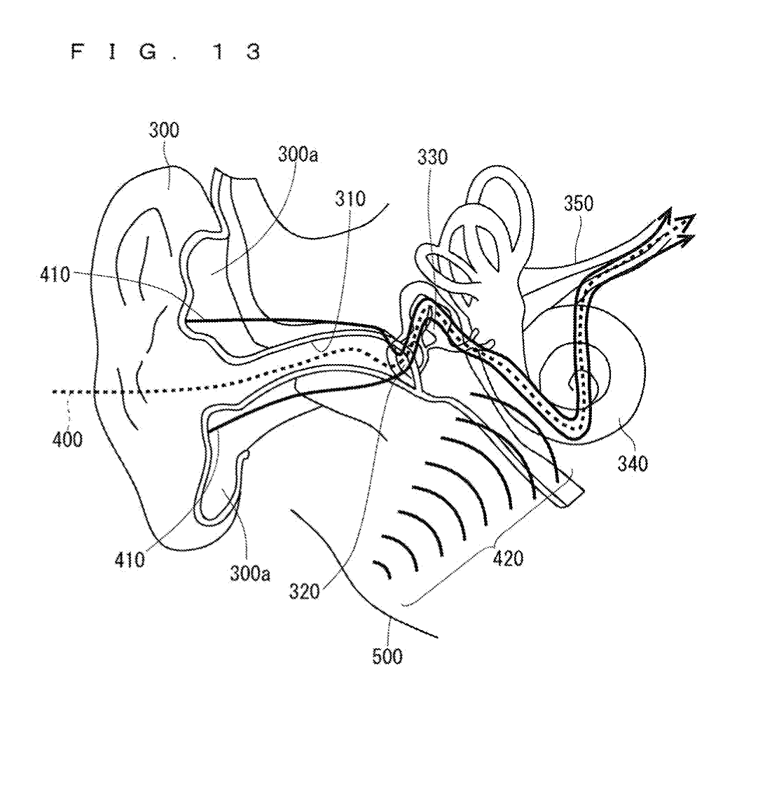

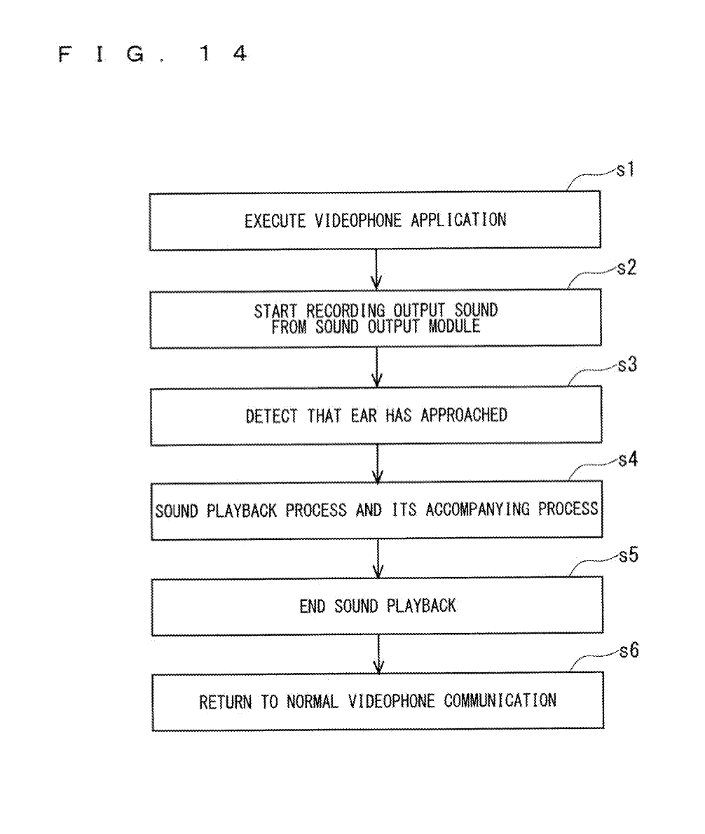

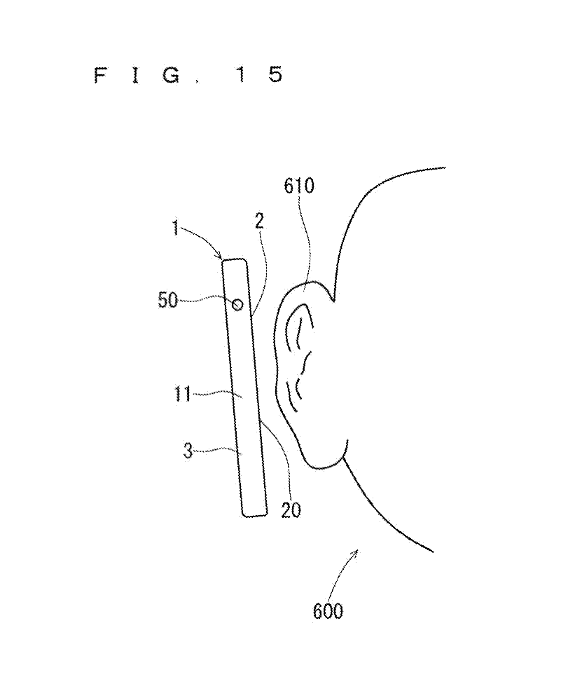

FIG. 13 is a view for describing the air conducted sound and conduction sound. FIG. 13 shows the structure of the ear of the user of the portable electronic device 1. In FIG. 13, a dashed line 400 indicates a conductive path of a sound signal (sound information) when the air conducted sound is recognized by the brain, and a solid line 410 indicates a conductive path of a sound signal when the conduction sound is recognized by the brain.

When the piezoelectric vibration element 221 mounted on the cover panel 2 is vibrated based on an electrical sound signal indicative of received sound, the cover panel 2 vibrates, whereby a sound wave is output from the cover panel 2. When the user has the portable electronic device 1 in his/her hand and brings the cover panel 2 of the portable electronic device 1 near an auricle 300 of the user or holds the cover panel 2 of the portable electronic device 1 to (brings the cover panel 2 of the portable electronic device 1 into contact with) the auricle 300 of the user, the sound wave output from the cover panel 2 enters an external auditory meatus 310. The sound wave from the cover panel 2 travels through the external auditory meatus 310 and causes an eardrum 320 to vibrate. The vibrations of the eardrum 320 are transmitted to an auditory ossicle 330, causing the auditory ossicle 330 to vibrate. Then, the vibrations of the auditory ossicle 330 are transmitted to a cochlea 340 and are then converted into an electrical signal in the cochlea 340. The electrical signal is transmitted to the brain through an auditory nerve 350, so that the brain recognizes the received sound. In this manner, the air conducted sound is transmitted from the cover panel 2 to the user.

When the user has the portable electronic device 1 in his/her hand and holds the cover panel 2 of the portable electronic device 1 to the auricle 300 of the user, the auricle 300 is vibrated by the cover panel 2 vibrated by the piezoelectric vibration element 221. The vibrations of the auricle 300 are transmitted to the eardrum 320, causing the eardrum 320 to vibrate. The vibrations of the eardrum 320 are transmitted to the auditory ossicle 330, causing the auditory ossicle 330 to vibrate. The vibrations of the auditory ossicle 330 are then transmitted to the cochlea 340 and are then converted into an electrical signal by the cochlea 340. The electrical signal is transmitted to the brain through the auditory nerve 350, whereby the brain recognizes the received sound. In this manner, the conduction sound is transmitted from the cover panel 2 to the user. FIG. 13 also shows an auricular cartilage 300a inside the auricle 300.

The conduction sound described herein differs from bone-conducted sound (also referred to as “bone conduction sound”). The bone-conducted sound is the sound recognized by the human brain when the skull is vibrated and the vibrations of the skull directly stimulate the inner ear such as the cochlea. In FIG. 13, showing the case in which, for example, a mandibular bone 500 is vibrated, a plurality of arcs 420 indicate a transmission path of a sound signal when the bone conduction sound is recognized by the brain.

As described above, in the portable electronic device 1 according to this embodiment, the piezoelectric vibration element 221 appropriately vibrates the cover panel 2 on the front surface, so that the air conducted sound and conduction sound can be transmitted from the cover panel 2 to the user of the portable electronic device 1. The structure of the piezoelectric vibration element 221 according to this embodiment is contrived to appropriately transmit the air conducted sound and conduction sound to the user. Various advantages can be achieved by configuring the portable electronic device 1 to transmit the air conducted sound and conduction sound to the user.

For example, the user can hear the sound by holding the cover panel 2 to his/her ear, and thus can have a telephone conversation without much consideration of the position of the portable electronic device 1 to which the user brings his/her ear.

For large ambient noise, the user can make it difficult to hear the ambient noise by putting his/her ear strongly to the cover panel 2 while turning up the volume of the conduction sound. This enables the user to appropriately have a telephone conversation even if the ambient noise is large.

Even while wearing earplugs or earphones in his/her ears, the user can recognize the received sound from the portable electronic device 1 by holding the cover panel 2 to his/her ear (more specifically, auricle). Alternatively, even while wearing headphones in his/her ears, the user can recognize the received sound from the portable electronic device 1 by holding the cover panel 2 to the headphones.

While a clearance is provided between the touch panel 130 and the display panel 120 in the above-mentioned example as shown in FIG. 11, the touch panel 130 and the display panel 120 may be brought into contact with each other. A clearance, provided between the touch panel 130 and the display panel 120 as in this embodiment, can prevent the cover panel 2 from hitting the display panel 120 (more accurately, the touch panel 130 from hitting the display panel 120) even if the cover panel 2 flexes toward the display panel 120 by being pressed by the user with, for example, his/her finger. This prevents a display of the display panel 120 from being disturbed by the cover panel 2 hitting the display panel 120.

As described above, the receiver 220 according to this embodiment is configured not with a dynamic speaker or the like to be used as the external speaker 180 but with the piezoelectric vibration element 221 to be vibrated based on a sound signal and the cover panel 2 on which the piezoelectric vibration element 221 is mounted. This eliminates the need for providing a receiver hole (earpiece hole) to the cover panel 2, unlike the case in which a dynamic speaker is used for the receiver 220.

<External Speaker and Playback Process for Output Sound from External Output Module by Receiver>

While the controller 100 is executing the application 105, the external speaker 180 may be used to output sound from the external speaker 180.

For example, in the case where the external speaker 180 is set as the sound output source while executing the voice conversation application, the controller 100 causes the external speaker 180 to output the voice contained in the voice data received by the wireless communication module 110.

In the case where the external speaker 180 is set as the sound output source while executing the videophone application, the controller 100 causes the display panel 120 to display a moving image contained in the moving image data with sound received by the wireless communication module 110 and also causes the external speaker 180 to output the voice contained in the moving image data with sound.

In the case where the external speaker 180 is set as the sound output source while executing the stored moving image playback application, the controller 100 causes the display panel 120 to display a moving image contained in the moving image data with sound in the storage module 103 and also causes the external speaker 180 to output the sound contained in the moving image data with sound.

The same holds true for the external output module 170. While the controller 100 is executing the application 105, the external output module 170 may be used to output the sound from the external output module 170. For example, in the case where the external output module 170 is set as the sound output source while executing the delivered moving image playback application, the controller 100 causes the display panel 120 to display a moving image contained in the moving image data with sound received by the wireless communication module 110 and also causes the external output module 170 to output the sound contained in the moving image data with sound. Hereinafter, the external output module 170 and the external speaker 180 may be collectively referred to as a “sound output module.”

When listening to the sound output from the external speaker 180, the user of the portable electronic device 1 may have difficulty in hearing the sound depending on the performance of the external speaker 180 or the surrounding environment. Alternatively, when listening to the sound output from the external output module 170 with a sound output device such as earphones, the user may have difficulty in hearing the sound depending on the performance of the sound output device or the surrounding environment. It is conceivable that in the case where the recorded sound (for example, English conversation) is played back by the sound output module, the user may play back the sound difficult to hear again and cause the sound output module to output this sound, thereby re-listening to the sound. On this occasion, even when the sound output module that has output the sound difficult to hear outputs the same sound again, the user is more likely to have difficulty in hearing this sound. Moreover, the user needs to manipulate the display part 2a of the portable electronic device 1 to rewind and play back the recorded sound.

The portable electronic device 1 according to this embodiment is thus configured such that when the user's ear is brought near the portable electronic device 1 while the sound output module is outputting the sound during the execution of the application 105 by the controller 100, the sound output from the sound output module is played back to be output from the receiver 220. In other words, the portable electronic device 1 is configured such that upon detecting that the user's ear is brought near the portable electronic device 1 while performing the sound output process of causing the sound output module to output the sound, the controller 100 performs the sound playback process of playing back the sound output from the sound output module and causing the receiver 220 to output sound. This allows the user, who had difficulty in hearing the sound from the sound output module, to re-listen to the sound difficult to hear using the receiver 220 provided separately from the sound output module by bringing his/her ear near or into contact with the portable electronic device 1. The user can accordingly re-listen to the sound difficult to hear with ease. Moreover, the user can re-listen to the sound difficult to hear from the sound output module using the receiver 220 provided separately from the sound output module, and is thus more likely to hear the sound in re-listening. The sound playback process by the receiver 220 will now be descried.

FIG. 14 is a flowchart showing the operation of the portable electronic device 1 when the receiver 220 performs the sound playback process while a videophone application is executed. As shown in FIG. 14, in Step s1, when the user manipulates the display part 2a of the cover panel 2 to instruct the portable electronic device 1 to execute the videophone application, the controller 100 reads the videophone application from the storage module 103 and executes the videophone application. Upon this, the portable electronic device 1 starts videophone communication with a communication partner device by means of the wireless communication module 110, the display panel 120, the microphone 190, and the sound output module (external speaker 180 or external output module 170). In the videophone communication, the sound output process of causing the sound output module to output the sound is performed.

In Step s2, next, the controller 100 starts recording the sound output from the sound output module (voice of the user of the communication partner device). For example, the controller 100 records the latest sound for a predetermined duration (for example, 30 seconds), which is received by the wireless communication module 110, while overwriting the sound, and stores the latest recorded sound for the predetermined duration in the storage module 103. Therefore, during the videophone communication, the storage module 103 always stores the latest voice (in detail, voice data) received from the communication partner device for a predetermined duration.

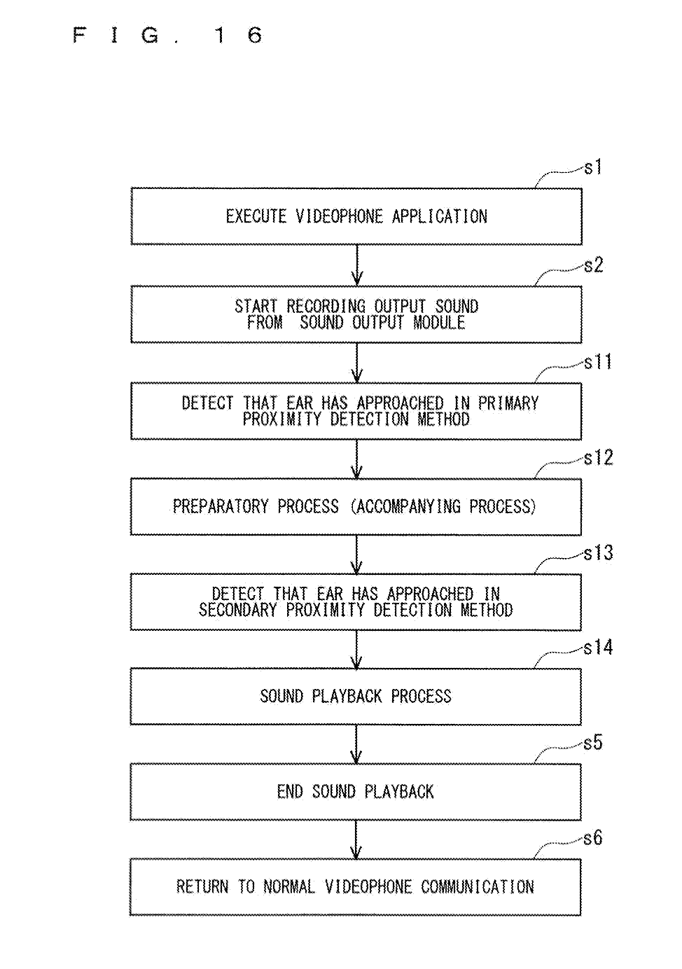

After recording of the sound output from the sound output module is started, in Step s3, the controller 100 detects that an ear 610 of a user 600 has approached the portable electronic device 1 as shown in FIG. 15, specifically, detects that the ear 610 of the user 600 has approached the cover panel 2 configuring the receiver 220 of the portable electronic device 1. Then, in Step s4, the controller 100 performs the sound playback process of playing back the sound output from the sound output module and causing the receiver 220 to output the sound. Hereinafter, the simply called “sound playback process” refers to the process of playing back the sound output from the sound output module and causing the receiver 220 to output the sound. When the user, who has listened to the sound output from the sound output module in videophone communication, has difficulty in hearing the sound from the sound output module, the user tries to bring his/her ear near the portable electronic device 1 to re-listen to the sound with the receiver 220. Then, the portable electronic device 1 performs Steps s3 and s4 in order. Detailed description will be given of the method of detecting that the user's ear has approached the portable electronic device 1.

In Step s4, the controller 100 plays back the recorded sound in the storage module 103 and causes the receiver 220 to output the sound. In this case, the recorded sound for a predetermined duration may be played back from the start or may be played back from in between. In the case where the recorded sound is played back from in between, the latest soundless moment may be specified for the recorded sound such that the recorded sound is played back from that soundless moment. As a result, the sound output from the sound output module is played back to be output from the cover panel 2 of the receiver 220. The user, whose ear is brought near or into contact with the cover panel 2, can thus re-listen to the playback sound from the cover panel 2 to re-listen to the sound difficult to hear from the sound output module. The controller 100 drives the piezoelectric vibration element 221 based on a sound signal (sound data) of the recorded sound, to thereby play back the sound and then cause the cover panel 2 to output the sound. In Step s4, double-speed playback may be performed to reduce a play back time in the playback of the recorded sound. For example, in the case where the sound has been temporarily difficult to hear due to the surrounding environment but later can be heard during the playback, double-speed playback may be performed to reduce a playback time such that a communication partner will wait as little as possible.

Upon execution of Step s3, in Step s4, the controller 100 performs the sound playback process as well as an accompanying process desired to be performed when the sound playback process is performed. In this embodiment, as an accompanying process, the controller 100 turns off a display of the display panel 120 by, for example, turning off the backlight of the display panel 120. Also, the controller 100 turns off the function of the sound output module as the accompanying process. In other words, the controller 100 stops a sound output from the sound output module. The user brings his/her ear near or into contact with the cover panel 2 of the receiver 220 to re-listen to the sound difficult to hear. Thus, the user may feel annoyed if the display of the display panel 120 is turned on and the moving image of videophone communication is displayed on the display part 2a of the cover panel 2. In the case where the user brings his/her ear near the cover panel 2, with the external speaker 180 being outputting the sound, the user may feel the sound from the external speaker 180 annoying or may have difficulty in hearing the sound from the cover panel 2 due to the sound from the external speaker 180. In the case where the user brings the ear opposite to the ear with the earphone near or into contact with the cover panel 2, with the earphone outputting the sound from the external output module 170, the user may feel the sound from the earphone annoying or may have difficulty in hearing the sound from the cover panel 2 due to the sound from the earphone. For this reason, in this embodiment, as the process accompanying the sound playback process, the controller 100 turns off a display of the display panel 120 and also stops a sound output from the sound output module. This process also achieves the effect that the power consumption of the portable electronic device 1 is reduced. In place of stopping a sound output from the sound output module, the volume of the sound output module may be turned down.

As the accompanying process, the controller 100 uses the wireless communication module 110 to notify the communication partner device performing videophone communication with the portable electronic device 1 of the execution of the sound playback process. To be specific, the controller 100 generates a notification signal for notification of the execution of the sound playback process. Then, the controller 100 causes the wireless communication module 110 to transmit the generated notification signal toward the communication partner device performing videophone communication. Upon notification of the execution of the sound playback process from the portable electronic device 1, the communication partner device notifies the user of the communication partner device of the execution of the sound playback process in the portable electronic device 1. For example, the communication partner device displays, on the display module of the own device, the information for notifying the execution of the sound playback process in the portable electronic device 1 (hereinafter, referred to as “sound-playback-process execution notifying information”). Displayed on the display module of the communication partner device is, for example, a character string “During re-listening to the sound” as the sound-playback-process execution notifying information. This allows the user of the communication partner device performing videophone communication with the portable electronic device 1 to recognize that the user of the portable electronic device 1 is re-listening to the sound output from the sound output module with the receiver 220. This prevents a situation that while the portable electronic device 1 is performing the sound playback process, the user of the communication partner device inadvertently recognizes that the communication between the communication partner device and the portable electronic device 1 has failed.

The controller 100 turns off the function of the microphone 190 as the accompanying process. In other words, as the accompanying, the controller 100 regards the sound to be input to the microphone 190 as invalid to prevent the sound to be input to the microphone 190 from being input to the communication partner device of the videophone communication. This prevents a situation in which, while the user of the portable electronic device 1 is re-listening to the sound with the receiver 220, the unnecessary sound is input to the communication partner device to annoy the user of the communication partner device. The controller 100 may turn off the function of the microphone 190 and also use the wireless communication module 110 to input music or the announcement “Please hold the line for a moment” to the communication partner device. In this case, the communication partner device transmits the input music or announcement to the user of the communication partner device with the external speaker or the like.

After the execution of the sound playback process and its accompanying process, in Step s5, the playback of the recorded sound by the receiver 220 is complete, in other words, the playback of the sound output from the sound output module by the receiver 220 is complete. In Step s6, then, the controller 100 allows the portable electronic device 1 to normally perform videophone communication. In other words, the controller 100 returns the operation of the portable electronic device 1 to the normal operation while executing the videophone application. To be specific, the controller 100 turns on a display of the display panel 120, turns on the function of the sound output module (in the case where the volume of the sound output module has been turned down, the controller 100 returns the volume to the original level), turns on the function of the microphone 190, and prevents the sound from being output from the receiver 220. As a result, a moving image, which is contained in the moving image data with sound received by the wireless communication module 110, is displayed on the display panel 120. The sound output module outputs the voice contained in the moving image data with sound. Then, the voice input to the microphone 190 is input to the communication partner device. The controller 100 uses the wireless communication module 110 to notify the communication partner device of the completion of the sound playback process. Upon notification of the completion of the sound playback process from the portable electronic device 1, the communication partner device erases the display of the sound-playback-process execution notifying information from the display portion thereof and returns the display of the display module to the normal state.

While the application 105 such as a videophone application, voice conversation application, delivered moving image playback application, or television viewing application is being executed, the sound output module outputs the sound to be input to the portable electronic device 1 in real time. In this case, to perform the sound playback process, the sound input to the portable electronic device 1 needs to be recorded as in Step s2 described above.

In contrast, when the application 105 such as a stored moving image playback application or music playback application is being executed, the sound that has been stored in the storage module 103 before the execution of the application 105 is played back to be output from the sound output module. Thus, Step s2 described above becomes unnecessary. As described above, in the case where the sound that has been stored before the execution of the application 105 is played back to be output from the external speaker 180 or the external output module 170, in the sound playback process in Step s4, the controller 100 rewinds and again plays back the stored sound being played back and then causes the receiver 220 to output the played-back sound. In this case, the controller 100 may rewind the recorded sound being played back by a predetermined duration upon detecting that the user's ear has approached the portable electronic device 1 in Step s3, or may rewind the recorded sound, which is being played back upon detecting that the user's ear has approached the portable electronic device 1, to the soundless moment closest to the moment of the above-mentioned detection. In the case of rewinding and again playing back the stored sound being played back and then causing the receiver 220 to output the sound, the controller 100 ends the playback of the output sound from the sound output module in the receiver 220 after the stored sound is played back to the moment before the sound is rewound (which corresponds to Step s5). Then, the controller 100 prevents the receiver 220 from outputting the sound and also turns on a display of the display panel 120 and turns on the function of the sound output module (which corresponds to Step s6). As a result, the operation of the portable electronic device 1 is returned to the normal operation while the application 105 is being executed.

<Methods of Detecting that Ear has Approached>

The controller 100 can detect that the user's ear has approached the portable electronic device 1 by various methods. Several types of the methods of detecting that the user's ear has approached the portable electronic device 1 will now be described.

<First Proximity Detection Method>

A first proximity detection method uses an output signal from the acceleration sensor 160. In the case where the user tries to hold the portable electronic device 1 in his/her hand and bring the cover panel 2 near his/her ear for listening to the sound from the cover panel 2 of the portable electronic device 1, the acceleration and speed of the portable electronic device 1 will increase. In the first proximity detection method, therefore, the controller 100 detects that the user's ear has approached the portable electronic device 1 based on the output signal from the acceleration sensor 160. To be specific, for example, when any one of the accelerations for three detection axes, which are output from the acceleration sensor 160, exceeds a threshold, the controller 100 judges that the user's ear has approached the portable electronic device 1. Alternatively, the controller 100 determines, from the accelerations for three detection axes output from the acceleration sensor 160, the speeds in the directions along the three detection axes for the three detection axes. Then, when any one of the determined three speeds exceeds a threshold, the controller 100 judges that the user's has approached the portable electronic device 1.

<Second Proximity Detection Method>

A second proximity detection method uses an output signal from the proximity sensor 150. As described above, when the portable electronic device 1 is viewed from the cover panel 2 side, the proximity sensor 150 is located on the rear side of the upper-side end portion of the cover panel 2. Thus, when the human head or the like approaches the cover panel 2, the proximity sensor 150 outputs a detection signal. In the second proximity detection method, thus, when the proximity sensor 150 outputs a detection signal while the sound output module such as the external speaker 180 is outputting the sound, the controller 100 judges that the user's ear has approached the portable electronic device 1.

<Third Proximity Detection Method>

A third proximity detection method uses the front-side imaging module 200 capable of imaging the object located in front of the portable electronic device 1. When the user tries to bring his/her ear near the cover panel 2, the front-side imaging module 200 in operation takes an image of the user's ear. In third proximity detection method, thus, the controller 100 operates the front-side imaging module 200 while the sound output module is outputting the sound. Then, when the front-side imaging module 200 takes an image of the user's ear, the controller 100 judges that the user's ear has approached the portable electronic device 1. Whether the front-side imaging module 200 has taken an image of the user's ear can be readily judged by analyzing an image signal output from the front-side imaging module 200.

<Fourth Proximity Detection Method>

A fourth proximity detection method uses the front-side imaging module 200 as in the third proximity detection method. The front-side imaging module 200 in operation takes an image of the user's face while the portable electronic device 1 is performing videophone communication. When the user tries to bring his/her ear near the cover panel 2, the front-side imaging module 200 fails to take an image of the user's face. Therefore, while the portable electronic device 1 is performing videophone communication, in other words, while the controller 100 is executing a videophone application, when the front-side imaging module 200 fails to take an image of the user's face, the controller 100 judges that the user's ear has approached the portable electronic device 1.

In the portable electronic device 1 according to this embodiment, while executing a videophone application, the controller 100 uses, in Step s3 above, at least one proximity detection method among the first to fourth proximity detection methods. While executing an application other than the videophone application, meanwhile, the controller 100 uses, in Step s3 above, at least one proximity detection method among the first to third proximity detection methods.

In the case of using a plurality of proximity detection methods in Step s3, the controller 100 performs Step s4 upon detecting that the user's ear has approached the portable electronic device 1 in at least one proximity detection method among the plurality of proximity detection methods. Alternatively, the controller 100 performs Step s4 upon detecting that the user's ear has approached the portable electronic device 1 in all of a plurality of proximity detection methods employed.

In Step s3, the controller 100 may detect that the user's ear has come into contact with the portable electronic device 1. In detecting that the user's ear has come into contact with the portable electronic device 1, the controller 100 uses, for example, an output signal from the touch panel 130 which detects that the object has come into contact with the display part 2a of the cover panel 2. To be specific, the controller 100 specifies the shape of the region in the display part 2a of the cover panel 2, into which the object has come into contact, based on the output signal from the touch panel 130. Then, the controller 100 judges, based on the specified shape, whether or not the user's ear has come into contact with the display part 2a of the cover panel 2. Hereinafter, this detection method is referred to as a “contact detection method.”

In the case of detecting in Step s3 that the user's ear has come into contact with the portable electronic device 1, the controller 100 also may or may not detect that the user's ear has approached the portable electronic device 1. In the case of only detecting in Step s3 that the user's ear has come into contact with the portable electronic device 1, the controller 100 performs Step s4 upon detecting that the user's ear has come into contact with the portable electronic device 1. Meanwhile, in the case of detecting that in Step s3 that the user's ear has approached the portable electronic device 1 and that it has come into contact with the portable electronic device 1, the controller 100 performs Step s4 upon detecting that the user's ear has approached the portable electronic device 1 and that it has come into contact with the portable electronic device 1.

In the case of detecting in Step s3 that the user's ear has approached the portable electronic device 1 and that it has come into contact with the portable electronic device 1, the controller 100 executing a videophone application uses the contact detection method and at least one of the first to fourth proximity detection methods. Also in this case, the controller 100 executing an application other than the videophone application uses the contact detection method and at least one of the first to third proximity detection methods. In the case of detecting in Step s3 that the user's ear has approached the portable electronic device 1 and that it has come into contact with the portable electronic device 1 and in the case of using a plurality of proximity detection methods, the controller 100 performs Step s4 upon detecting that the user's ear has approached the portable electronic device 1 in at least one detection method among the plurality of proximity detection methods and detecting that the user's ear has come into contact with the portable electronic device 1 in the contact detection method. Alternatively, the controller 100 performs Step s4 upon detecting that the user's ear has approached the portable electronic device 1 in all of a plurality of proximity detection methods employed and detecting that the user's ear has come into contact with the portable electronic device 1 in the contact detection method.

Although the receiver 220 is configured with the piezoelectric vibration element 221 and the cover panel 2 in the example above, it may be configured with a loudspeaker similar to the external speaker 180, for example, a dynamic speaker. In this case, the hole for receiver that is provided for outputting the sound output from the receiver 220 installed in the portable electronic device 1 to the outside of the portable electronic device 1 is made at, for example, the upper end portion of the cover panel 2. The user listens to the sound from the receiver 220 by bringing his/her ear near or into contact with the hole for receiver which is provided in the cover panel 2.

As described above, in this embodiment, upon detecting at least one of that the user's ear has approached the portable electronic device 1 and that it has come into contact with the portable electronic device 1 while the sound output module such as the external speaker 180 is outputting sound, the controller 100 plays back the sound output from the sound output module and causes the receiver 220 to output the sound. In other words, upon occurrence of at least one of the user's ear approaching the portable electronic device 1 and the user's ear coming into contact with the portable electronic device 1 while the sound output module is outputting sound, the controller 100 plays back the sound output from the sound output module and causes the receiver 220 to output the sound. Thus, the user, who had difficulty in hearing the sound output from the sound output module, brings his/her ear near or into contact with the portable electronic device 1 to listen to the sound difficult to hear from the receiver 220. As a result, the user can easily re-listen to the sound difficult to hear. Moreover, the user re-listens to the sound difficult to hear from the sound output module using another receiver 220 different from the sound output module, and thus, more easily re-listens to the sound in re-listening.

The receiver 220 is configured with the cover panel 2 and the piezoelectric vibration element 221 provided on the inner main surface 21 of the cover panel 2 as in this embodiment, so that the user can more easily listen to the sound from the receiver 220 by strongly putting his/her ear to the cover panel 2. This prevents such a situation that the user still has difficulty in hearing the sound even when re-listening to the sound with the receiver 220.

<Modifications>

<First Modification>

In the use of the receiver 220 including the piezoelectric vibration element 221 and the cover panel 2, as described above, the user can recognize the sound from the receiver 220 by putting his/her ear to the cover panel 2 even while wearing an earphone in his/her ear. Thus, when the same sound is output from the earphone and the receiver 220, the user can more easily listen to the sound.

The user can recognize the sound from the receiver 220 by putting the cover panel 2 to headphones even while wearing the headphones to his/her ears. Thus, when the same sound is output from the headphones and the receiver 220, the user can more easily listen to the sound.

Considered in this modification is a situation where in re-listening to the sound with the receiver 220, the user listening to the sound with a sound output device such as earphone puts the ear with the earphone to the cover panel 2 or puts the cover panel 2 to the headphones. While causing the external output module 170 to output the sound, in Step s4 above, the controller 100 plays back the sound output from the external output module 170 and causes not only the receiver 220 but also the external output module 170 to output the sound. This allows the sound difficult to hear to be output from both of the sound output device and the cover panel 2, preventing a situation in which the user again has difficulty in hearing the sound in re-listening.

<Second Modification>

The user re-listening to the sound output from the sound output module with the receiver 220 may want to, also after re-listening to the sound, listen to the sound (the voice of the user of the communication partner device, which is received by the wireless communication module 110 while the videophone application is being executed) output from the sound output module while the application 105 is being executed, using the receiver 220.

In this modification, therefore, when the playback of the sound output from the sound output module in the receiver 220 is complete, with the user's ear being close to or in contact with the portable electronic device 1, the controller 100 causes the receiver 220 to output the sound to be output from the sound output module while executing the application 105. In other words, when the playback of the sound output from the sound output module with the receiver 220 is complete, with the user's ear, which is close to or in contact with the portable electronic device 1, remaining at the portable electronic device 1, the controller 100 causes the receiver 220 to output the sound to be output from the sound output module while executing the application 105. This allows the user to re-listen to the sound with the receiver 220 and then listen to the sound to be output from the sound output module also with the receiver 220 while the application 105 is being executed. While executing the videophone application, the controller 100 may cause the receiver 220 to output the sound to be output from the sound output module (voice of the user of the communication partner device) while executing the videophone application and also turn on the function of the microphone 190 to cause the portable electronic device 1 to have a voice conversation using the receiver 220 and the microphone 190.

Upon completion of the playback of the sound output from the sound output module with the receiver 220, with the user's ear being close to or in contact with the portable electronic device 1, the user's ear becomes apart from the portable electronic device 1. Then, the controller 100 returns the operation of the portable electronic device 1 to a normal operation while executing the application 105. In other words, when the user's ear becomes apart from the portable electronic device 1, the controller 100 prevents the receiver 220 from outputting the sound and turns on a display of the display panel 120 that has been turned off and turns on the function of the sound output module that has been turned off (in the case where the volume of the sound output module has been turned down, the controller 100 returns the volume to the original level). Then, the controller 100 notifies the communication partner device of the completion of the sound playback process with the wireless communication module 110.

In the case where the playback of the sound in the receiver 220 is complete, with the user keeping his/her ear apart from the portable electronic device 1, as described with reference to FIG. 14, upon completion of the playback of the sound in the receiver 220, the controller 100 returns the operation of the portable electronic device 1 to the normal operation while executing the application 105.

As in the case of detecting that the user's ear has approached or has come in contact with the portable electronic device 1, the controller 100 can detect that the user's ear has become apart from the portable electronic device 1 with the acceleration sensor 160, the proximity sensor 150, the front-side imaging module 200, or the touch panel 130.

The user moves the portable electronic device 1 off his/her ear while holding the portable electronic device 1 in his/her hand, and accordingly, the acceleration and speed of the portable electronic device 1 increase when the user's ear becomes apart from the portable electronic device 1. Thus, as in the case of detecting that the user's ear has approached the portable electronic device 1, the controller 100 can detect that the user's ear has become apart from the portable electronic device 1 based on the output signal from the acceleration sensor 160.

When the user's ear becomes apart from the portable electronic device 1, the proximity sensor 150 fails to output a detection signal. Thus, in the case where the proximity sensor 150 fails to output a detection signal, the controller 100 judges that the user's ear has become apart from the portable electronic device 1.

When the user's ear becomes apart from the portable electronic device 1, the front-side imaging module 200 fails to take an image of the user's ear. When the front-side imaging module 200 cannot take an image of the user's ear, the controller 100 judges that the user's ear has become apart from the portable electronic device 1. In the case where the user's ear has come excessively close to or come in contact with the display part 2a of the portable electronic device 1, even if the front-side imaging module 200 takes an image of the ear, the controller 100 may fail to recognize that the front-side imaging module 200 has taken an image of the ear based on the taken image. In such a case, the controller 100 judges that the front-side imaging module 200 has taken an image of the ear based on the image taken by the front-side imaging module 200 once the user's ear becomes a little apart from the display part 2a. After that, when the ear becomes further apart from the display part 2a and the front-side imaging module 200 fails to take an image of the ear, the controller 100 may judge that the user's ear has become apart from the portable electronic device 1. The controller 100 may use the above-mentioned method in combination with other detection method so as to more accurately detect that the user's ear has become apart from the portable electronic device 1.

When the user's ear being in contact with the display part 2a of the portable electronic device 1 becomes apart from the portable electronic device 1, the touch panel 130 fails to detect that the user's ear comes into contact with the display part 2a. The controller 100 can accordingly detect that the user's ear has become apart from the portable electronic device 1 based on the output signal from the touch panel 130.

<Third Modification>

The first to fourth proximity detection methods described above differ in the timing at which detection results are obtained, or, the timing at which it is detected that the user's ear has approached the portable electronic device 1. To be specific, the timing at which detection results are obtained is earlier in the order of the first proximity detection method using the acceleration sensor 160, the fourth proximity detection method of judging whether the front-side imaging module 200 fails to take an image of the face, the third proximity detection method of judging whether the front-side imaging module 200 can take an image of the ear, and the second proximity detection method using the proximity sensor 150. In other words, as the user's ear approaches the portable electronic device 1, detection results are obtained in the order of the first proximity detection method, the fourth proximity detection method, the third proximity detection method, and the second proximity detection method. In the execution of an application other than the videophone application, the fourth proximity detection method cannot be employed and, in such a case, the timing at which detection results are obtained is earlier in the order of the first proximity detection method, the third proximity detection method, and the second proximity detection method.

Meanwhile, in the execution of the sound playback process as descried above, the accompanying process such as turning off a display of the display panel 120 is performed. The accompanying process is desirably performed at a stage as early as possible when the user tries to bring his/her ear near the portable electronic device 1 to listen to the playback sound from the receiver 220.

For example, in the case where the user brings his/her ear near or into contact with the portable electronic device 1 to start listening to the playback sound from the receiver 220 and, after a while, turns off a display of the display panel 120, the user may feel annoyed for a while.

In the case where the user starts listening to the playback sound from the receiver 220 and, after a while, stops a sound output from the sound output module, the user may feel annoyed or have difficulty in hearing the sound from the receiver 220.

While the videophone application is being executed, in the case where the user starts listening to the playback sound from the receiver 220 and, after a while, turns off the function of the microphone 190, the user of the communication partner device may feel uncomfortable for a while due to the unnecessary sound transmitted.

While the conversation-related application such as a videophone application or a voice conversation application is being executed, when the user starts listening to the playback sound from the receiver 220 and, after a while, the communication partner device is notified of the execution of the sound playback process by the portable electronic device 1, the user of the communication partner device may misunderstand for a while that a failure has occurred in the communication between the communication partner device and the portable electronic device 1.

As described above, when the user tries to bring his/her ear near the portable electronic device 1, the process accompanying the sound playback process is desirably performed at a stage as early as possible.

In this modification, therefore, the controller 100 uses two proximity detection methods, in which the timing at which the detection results are obtained differ, to perform the accompanying process as the preparatory process before performing the sound playback process, thereby performing the accompanying process as early as possible. To be specific, upon detecting that the user's ear has approached the portable electronic device 1 in the proximity detection method in which the detection results are obtained earlier of the two proximity detection methods employed, the controller 100 performs the accompanying process. Then, upon detecting that the user's ear has approached the portable electronic device 1 in the proximity detection method in which the detection results are obtained later, the controller 100 performs the sound playback process. In other words, the controller 100 performs the accompanying process upon detecting that the user's ear has approached the portable electronic device 1 and performs the sound playback process upon detecting that the user's ear has further approached the portable electronic device 1. Hereinafter, of the two proximity detection methods employed by the controller 100, the proximity detection method of obtaining detection results earlier is referred to as a “primary proximity detection method,” whereas the proximity detection method of obtaining detection results later is referred to as a “secondary proximity detection method.” Alternatively, the accompanying process may be referred to as a preparatory process.

Various combinations are conceivable as the combination of the primary proximity detection method and the secondary proximity detection method. For example, the first proximity detection method may be employed as the primary proximity detection method and the second proximity detection method may be employed as the secondary proximity detection method. While the controller 100 is executing the videophone application, the fourth proximity detection method may be employed as the primary proximity detection method and the third proximity detection method may be employed as the secondary proximity detection method. Description will now be given of the operation of the portable electronic device 1 according to this modification while the controller 100 is executing a videophone application as in FIG. 14. FIG. 16 is a flowchart showing this operation.

As shown in FIG. 16, Step s1 described above is performed, so that the videophone application is executed. Then, Step s2 described above is performed, so that recording of the sound output from the sound output module is started.

After recording of the sound output from the sound output module is started, in Step s11, the controller 100 detects that the user's ear has approached the portable electronic device 1 in the primary proximity detection method. Then, in Step s12, the controller 100 performs the preparatory process (accompanying process) before the execution of the sound playback process. In this preparatory process, as described above, a display of the display panel 120 is turned off, a sound output of the sound output module is stopped, the function of the microphone 190 is turned off, and the execution of the sound playback process is notified the communication partner device.

After that, in Step s13, upon detecting that the user's ear has approached the portable electronic device 1 in the secondary proximity detection method, that is, upon detecting that the user's ear has further approached the portable electronic device 1, the controller 100 performs the sound playback process in Step s14.

After Step s14 is performed, in Step s5, the receiver 220 ends the playback of the sound output from the sound output module. Then, Step s6 described above is performed, so that the controller 100 allows the portable electronic device 1 to perform normal videophone communication.

In the example above, the controller 100 performs the preparatory process when the user's ear approaches the portable electronic device 1, and then, performs the sound playback process when the user's ear further approaches the portable electronic device 1. In place of the above-mentioned process, the controller 100 may perform the preparatory process when the user's ear approaches the portable electronic device 1, and then, may perform the sound playback process when the user's ear comes into contact with the portable electronic device 1. In this case, the controller 100 employs the proximity detection method and the contact detection method. In other words, in Step s11 described above, one proximity detection method of the first to fourth proximity detection methods is employed to detect that the user's ear has approached the portable electronic device 1, and then in Step s12, the preparatory process is performed. After that, in Step s13, the contact detection method is employed to detect that the user's ear has come into contact with the portable electronic device 1. In Step s14, then, the sound playback process is performed.

As described above, in this modification, while performing the sound output process of causing the sound output module to output sound, the controller 100 performs the preparatory process before performing the sound playback process upon detecting that the user's ear has approached the portable electronic device 1. After that, the controller 100 performs the sound playback process upon detecting that the user's ear has further approached or has come into contact with the portable electronic device 1. Thus, the preparatory process is performed at a stage as early as possible when the user tries to bring his/her ear near the portable electronic device 1 to listen to the playback sound from the receiver 220. This prevents the occurrence of the problem attributable to the execution of the sound playback process. For example, when the user tries to listen to the playback sound output from the receiver 220 through the execution of the sound playback process, the occurrence of a problem can be prevented, such as a problem that the user feels annoyed because sound is output from the sound output module, for example, external speaker 180.

<Other Modifications>

Although the portable electronic device 1 and the sound output device such as earphones are in wired connection in the examples above, they may be in wireless connection. To be specific, for example, a near-field wireless communication module, which is capable of near-field wireless communication by Bluetooth (registered trademark), is provided separately from the external output module 170 or in place of the external output module 170. The near-field wireless communication module outputs the sound (sound signal) to the Bluetooth-compliant earphones or headphones. In this case, similarly to the external output module 170, the near-field wireless communication module functions as the external output module that outputs the sound to the sound output device, and the near-field wireless communication module is also included in the sound output module. In this case, therefore, when the user's ear approaches or comes into contact with the portable electronic device 1 while the near-field wireless communication module is outputting the sound to the sound output device, the sound output from the near-field wireless communication module is played back to be output from the receiver 220.

The examples above have been given of the case where the embodiments of the present disclosure is applied to a mobile phone. Alternatively, the embodiments of the present disclosure is also applicable to portable electronic devices other than mobile phones as long as the devices include a receiver and a sound output module provided separately from the receiver.

The portable electronic device 1 has been described in detail, but the above-mentioned description is illustrative in all aspects and the embodiments of the present disclosure is not intended to be limited thereto. The examples described above are applicable in combination as long as they do not contradict each other. Various modifications not exemplified are construed to be made without departing from the scope of the present disclosure.

### DESCRIPTION OF REFERENCE SIGNS

1 portable electronic device
2 cover panel
21 inner main surface
100 controller
120 display panel
130 touch panel
150 proximity sensor
160 acceleration sensor
170 external output module
180 external speaker
190 microphone
200 front-side imaging module
220 receiver
221 piezoelectric vibration element

1. A portable electronic device comprising:
a receiver;
a sound output module located separately from said receiver; and
a controller configured to control said receiver and said sound output module,
wherein upon occurrence of at least one of an ear of a user of said portable electronic device approaching said portable electronic device and the ear of said user coming into contact with said portable electronic device while performing a sound output process of causing said sound output module to output sound, said controller performs a sound playback process of playing back the sound output from said sound output module in said sound output process and causing said receiver to output the played-back sound.

2. The portable electronic device according to claim 1, wherein said controller performs a preparatory process upon the ear of said user approaching said portable electronic device while performing said sound output process, and then performs said sound playback process upon said ear further approaching or coming into contact with said portable electronic device.

3. The portable electronic device according to claim 2, wherein said preparatory process includes turning down a volume of said sound output module or stopping a sound output of said sound output module.

4. The portable electronic device according to claim 2, further comprising a display module,
wherein said preparatory process includes turning off a display of said display module.

5. The portable electronic device according to claim 2, further comprising:
a sound input module; and
a communication module configured to communicate with a communication partner device, wherein
said controller controls said sound output module, said sound input module, and said communication module,
in said sound output process, said controller causes said sound output module to output sound while said portable electronic device is performing a telephone conversation, and
said preparatory process includes at least one of notifying a communication partner device of the execution of said sound playback process with said communication module and turning off a function of said sound input module.

6. The portable electronic device according to claim 1, further comprising a proximity sensor,
wherein said controller detects that an object has approached said portable electronic device based on an output signal from said proximity sensor, and said controller performs the sound playback process when said controller detects that an object has approached said portable electronic device while performing the sound output process.

7. The portable electronic device according to claim 1, further comprising an imaging module,
wherein upon said imaging module taking an image of the ear of said user while performing said sound output process, said controller judges that said ear has approached said portable electronic device.

8. The portable electronic device according to claim 1, further comprising a touch panel configured to detect that an object has come into contact with said portable electronic device,
wherein said controller detects that an object has come into contact with said portable electronic device based on an output signal from said touch panel, and said controller performs the sound playback process when said controller detects that an object has come into contact with said portable electronic device while performing the sound output process.

9. The portable electronic device according to claim 1, further comprising:
an imaging module;
a display module;
a sound input module; and
a communication module configured to communicate with a communication partner device, wherein
said controller controls said imaging module, said display module, said sound output module, said sound input module, and said communication module,
in said sound output process, said controller causes said sound output module to output sound while said portable electronic device is performing videophone communication, and
said controller judges that the ear of said user has approached said portable electronic device when said imaging module become unable to take an image of a face of said user while said portable electronic device is performing videophone communication.

10. The portable electronic device according to claim 1, wherein said controller causes, in said sound playback process, said receiver to output the sound output in said sound output process upon completion of the sound playback while the ear of said user is close to or is in contact with said portable electronic device, and then, prevents said receiver from outputting sound when the ear of said user becomes apart from said portable electronic device.

11. The portable electronic device according to claim 10, wherein
upon occurrence of at least one of the ear of said user approaching said portable electronic device and the ear of said user coming into contact with said portable electronic device while performing said sound output process, said controller performs said sound playback process and also turns down a volume of said sound output module or stops a sound output of said sound output module, and
when the ear of said user becomes apart from said portable electronic device, said controller prevents said receiver from outputting sound and also returns the volume of said sound output module to an original level or restarts a sound output of said sound output module.

12. The portable electronic device according to claim 10, further comprising a display module, wherein
upon occurrence of at least one of the ear of said user of said portable electronic device approaching said portable electronic device and the ear of said user coming into contact with said portable electronic device while performing said sound output process, said controller performs said sound playback process and also turns off a display of said display module, and
when the ear of said user becomes apart from said portable electronic device, said controller prevents said receiver from outputting sound and also turns on a display of said display module.

13. The portable electronic device according to claim 1, wherein
in a case of causing said sound output module to output in real time the sound to be input to said portable electronic device in said sound output process, said controller records said sound, and plays back said recorded sound and causes said receiver to output said recorded sound in said sound playback process, and
in a case of playing back the stored sound and causing said sound output module to output said stored sound in said sound output process, said controller rewinds and plays back said stored sound in said sound playback process.

14. The portable electronic device according to claim 1, wherein said receiver includes:
a cover panel located on a front surface of said portable electronic device; and
a piezoelectric vibration module configured to be located on an inner surface of said cover panel and be vibrated based on a sound signal.

15. The portable electronic device according to claim 14, wherein
said sound output module is an external output module configured to output sound to earphones or headphones, and
in said sound playback process, said controller plays back the sound output from said external output module in said sound output process and causes said receiver and said external output module to output the played-back sound.

16. The portable electronic device according to claim 14, wherein said piezoelectric vibration module vibrates said cover panel such that air conducted sound and conduction sound are transmitted from said cover panel to said user.
